(19) United States
(12) Patent Application Publication
(10) Pub. No.: US 2006/0221236 A1
(43) Pub. Date: Oct. 5, 2006

(54) Television with number displaying function

(75) Inventors: Mei-hsiu Cheng, Taipei (TW); Mei-Chi Kuo, Taipei (TW); Wen-Yi Chang, Taipei (TW); Min-Tzu Sung, Taipei (TW)

Correspondence Address: FULBRIGHT AND JAWORSKI LLP, 555 S. FLOWER STREET, 41ST FLOOR, LOS ANGELES, CA, 90071, US

(73) Assignee: INVENTEC CORPORATION

(21) Appl. No.: 11/097,423

(22) Filed: Mar. 31, 2005

(51) Int. Cl. H04N 5/44; H04N 5/445

(52) U.S. Cl. 348/564; 348/553; 348/734

(57) ABSTRACT

A television with number displaying function is provided to allow a user waiting in a queue to see the queue number simultaneously while watching a television program. The television with number displaying function comprises a display unit for showing television program as well as number at the same time; a wireless controlling device for providing a number controller remotely for altering the number and the way it is displayed on the display unit; a receiver for receiving a signal sent by the wireless controlling device, and a controlling unit for implementing the program stored in a memory unit according to the signal received by the receiver. This eliminates the need for the user to check from time to time the queue number being called upon and also reduces the possibility of missing the queue number when the user is too concentrated in watching television, when the queue number is conventionally displayed in a separate device from the television.

### FIELD OF THE INVENTION

The present invention relates to a technology of displaying numbers, and more particularly, to a television that can show television programs and numbers on the display of the television at the same time.

### BACKGROUND OF THE INVENTION

In busy cities, apparently everyone has experienced queuing and waiting, no matter it is queuing for an appointment in a hospital, a banking service in a bank, an ordered food in a restaurant. Queuing in a line not only occupies spaces but also forbids a person who is waiting in the queue to leave the line and pursue something else while waiting. It is thus time consuming as well as frustrating.

Therefore, numbered cards are given out to people to replace the conventional way of personally queuing in a line, so that people can sit down and watch television or read magazine etc. and will be summoned when a numbering display machine shows the same number he/she has on his/her card.

Conventionally, the numbering display machine and the television are separately provided, such that people who are watching the television while waiting have to check the numbering display machine from time to time. This causes a lot of inconvenience. Sometimes, one may even miss the call when one is too concentrated on watching the television program.

### SUMMARY OF THE INVENTION

From the above technical drawbacks, a main objective of the present invention is to provide a television with number displaying function, which shows both number and television program on the screen of the television to provide a user to see queue number while watching television program at the same time. This eliminates the need for the user to check from time to time the queue number being called upon and also reduces the possibility of missing the queue number when the user is too concentrated in watching television, when the queue number is conventionally displayed in a separate device from the television.

To achieve the above objective, the present invention provides a television with number displaying function. The television with number displaying function of the present invention comprises: a controlling unit, an output unit, a wireless controlling device, a receiver, and a memory unit. The output unit can display both television program and number simultaneously and also make a number switching ringing tone, allowing the user to see instant queue number while watching television program at the same time, as well as notified of the switching number via the ringing tone. The wireless controlling device provides the user to remotely alter the number and number switching ringing tone outputted by the output unit and the different ways of displaying the number by sending signals to the receiver. The receiver is used to receive signals sent by the wireless controlling device and then forward the signals to the controlling unit. The memory unit calculates the number to be displayed and stores the displaying settings for the display of the number in accordance with the signals received by the receiver.

### BRIEF DESCRIPTION OF THE DRAWINGS

The present invention can be more fully understood by reading the following detailed description of the preferred embodiments, with reference made to the accompanying drawings, wherein:

FIG. 1 is a block diagram that shows a basic structure of a television that can display numbers according to the present invention.

### DETAILED DESCRIPTION OF THE PREFERRED EMBODIMENTS

Reference will now be made in detail to the preferred embodiment of the present invention, the advantages and functions of the present invention can be understood by those skilled in the art after reading the detailed description. The present invention should cover various modifications and variations made to the herein-described structure and operations of the present invention, provided they fall within the scope of the present invention.

### Preferred Embodiment

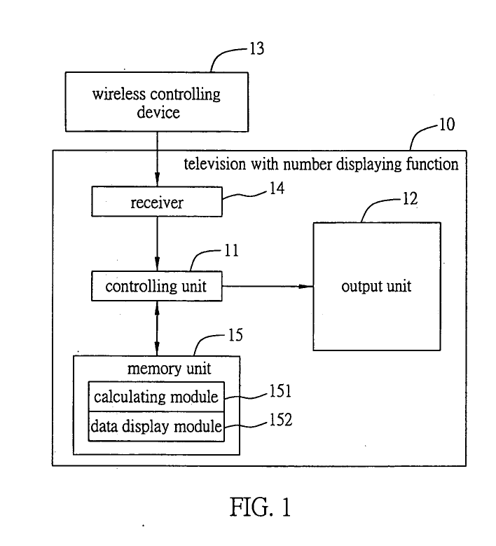

FIG. 1 is a block diagram showing a basic structure of a television having a function of displaying numbers according to the present invention. As shown in the diagram, a television for displaying numbers 10 of the invention comprises a controlling unit 11, an output unit 12, a wireless controlling device 13 (which can be an infrared or Bluetooth controlling device), a receiver 14 (which can be an infrared or Bluetooth receiver) and a memory unit 15.

The controlling unit 11 is a central processing unit of the television for displaying numbers 10, and is electrically connected to the output unit 12, the receiver 14 and the memory unit 15. Its main function is to implement the program stored in the memory unit 15, analyze and process signals received by the receiver 14.

The output unit 12 (e.g. a LCD display) can show a television program and a number on the same screen simultaneously. The system thus allows a user to notice the number displayed while watching television program at the same time. A ringing sound is also made when the number is switched so that the user is notified when the number is changed. The number can be displayed as a scrolling or flashing number or a fixed-light display. Moreover, how a television program is displayed simultaneously with another message is well known in the art, thus it will not be described further in order to maintain clarity of the description.

The wireless controlling device 13 sends signals to the receiver 14; the signals includes alteration of numbers, choice of display method for the number and alteration of the ringing tone, which allows a number controller (not shown) to remotely alter the number and ringing tone shown on the output unit 12, and also provides the number controller to choose different display method for numbers.

The receiver 14 is used to receive the signals sent by the wireless controlling device 13 and forward the signals to the controlling unit 11 for analysis and processing.

The memory unit 15 is used to store a calculating module 151 and data display module 152, wherein the calculating module 151 can perform accumulation of the number. Therefore, when it is time to switch to the next number, the number is accumulated by one. The data display module 152 provides settings of display locations, display methods and the ringing tones etc. The operations of the calculating module 151 and the data display module 152 are further explained as follows.

When the wireless controlling device 13 delivers a signal of ‘next number’ to the receiver 14, the receiver 14 then sends it to the controlling unit 11. Then, the controlling unit 11 makes the calculating module 151 in the memory unit 15 accumulates the currently stored number by one. The resulting accumulated number is then read by the controlling unit 11. Thereafter, the data display module 152 is implemented, so as to display the number on the output unit 12 according to the various settings such as the display location, the display method and the switching ringing tone stored in the module.

When the wireless controlling device 13 sends another signal of ‘number switching+29’, the signal is sent to the controlling unit 11 after receiving by the receiver 14, and the controlling unit 11 reads the calculating module 151 in the memory unit 15 to switch the currently displayed number to 29, then the data display module 152 is implemented, so as to display the number on the output unit 12 according to the various settings such as the display location, the display method and the switching ringing tone stored in the module.

When the wireless controlling device 13 sends yet another signal of ‘29+flash’, the signal is sent to the controlling unit 11 after receiving by the receiver 14, and the controlling unit 11 reads the data display module 152 in the memory unit 15, and then a flash setting is set to ‘Yes’ in the data display module 152, thus the number 29 is displayed in a flashing manner.

When the wireless controlling device 13 sends yet another signal of ‘29+scrolling to the right’, the signal is sent to the controlling unit 11 after receiving by the receiver 14, and the controlling unit 11 reads the data display module 152 in the memory unit 15, then the scroll setting is set to ‘Yes’ in the data display module 152, also the direction of scrolling setting is set to ‘R’ to make number 29 scrolling from left towards right on the output unit 12. Conversely, when ‘29+scrolling to the left’ is chosen, only the scrolling direction setting is set to ‘L’ while the rest is the same.

The invention has been described using exemplary preferred embodiments. However, it is to be understood that the scope of the invention is not limited to the disclosed embodiments. On the contrary, it is intended to cover various modifications and arrangements. The scope of the claims, therefore, should be accorded then broadest interpretation so as to encompass all such modifications and similar arrangements.

What is claimed is:

1. A television with number displaying function, comprising:
a wireless controlling device allowing a user to remotely switch the number displayed on the television;
a controlling unit;
a memory unit electrically connected to the controlling unit and used to store a calculating module and data display module;
an output unit electrically connected to the controlling unit and used to simultaneously show image information of a television program and the number simultaneously; and
a receiver electrically connected to the controlling unit and used to receive a signal sent by the wireless controlling device, wherein the controlling unit implements the calculating module and the data display module stored in the memory unit according to the signal received, thereby the number is displayed on the output unit according to display settings prescribed by the wireless controlling device.

2. The television with number displaying function of claim 1, wherein the wireless controlling device is an infrared transmission device.

3. The television with number displaying function of claim 1, wherein the wireless controlling device is a Bluetooth transmission device.

4. The television with number displaying function of claim 1, wherein the calculating module is used to accumulate the current number thus to implement the next number to be displayed.

5. The television with number displaying function of claim 1, wherein the data display module is used to set a display location for the number.

6. The television with number displaying function of claim 1, wherein the data display module is used to set a switching ringing tone for the number.

7. The television with number displaying function of claim 1, wherein the data display module is used to set a display method for the numbered message.

8. The television with number displaying function of claim 7, wherein the display method for the number comprises at least one selected from the group of flashing, scrolling towards left and scrolling towards right.

9. The television with number displaying function of claim 6, wherein the output unit provides the number switching ringing tones.

10. The television with number displaying function of claim 1, wherein the receiver is an infrared receiver.

11. The television with number displaying function of claim 1, wherein the receiver is a Bluetooth receiver.
